(19) United States
(12) Patent Application Publication
(10) Pub. No.: US 2023/0150076 A1
(43) Pub. Date: May 18, 2023

(54) TAG HOLDING CASSETTE ASSEMBLY FOR USE IN ENGRAVING MACHINES

(71) Applicant: THE HILLMAN GROUP, INC., Cincinnati, OH (US)

(72) Inventor: James F. Huss, Scottsdale, AZ (US)

(21) Appl. No.: 18/157,383

(22) Filed: Jan. 20, 2023

Related U.S. Application Data
(63) Continuation-in-part of application No. 16/999,110, filed on Aug. 21, 2020.
(60) Provisional application No. 62/890,679, filed on Aug. 23, 2019.

(51) Int. Cl. B23Q 3/06; B23Q 3/10

(52) U.S. Cl. CPC B23Q 3/062; B23Q 3/102

(57) ABSTRACT

A tag cassette assembly for use in connection with an engraving process carried out in an engraving machine includes a single piece cassette body of plastic material, the cassette body including a first major side and a second major side and a periphery formed by minor edges; a tag secured in a capture space of the cassette body; wherein the cassette first major side is configured to provide access to a first side of the tag to facilitate engraving and the second major side is configured to provide access to a second side of the tag to facilitate engraving.

### TECHNICAL FIELD

This application relates generally to engraving of tags, such as pet identification tags, and more particularly, to cassette assemblies for holding tags during the engraving process.

### BACKGROUND

Self-service pet tag marking kiosks are known. Such kiosks may be located near a display of pet tag options, where each pet tag is held in a cassette. The cassette holds and displays the tag, and displays information regarding the tag, as well as a scannable purchasing and identification code, such as a bar code. A consumer desiring to engrave a tag selects a pet tag cassette, purchases the cassette at a point-of-sale, and is provided with an access code that enable the consumer to utilize the pet marking kiosk to mark the tag (e.g., with pet name and owner contact information). At the kiosk, the consumer inputs the access code at the kiosk, scans the cassette identification code at the kiosk, inserts the cassette into a kiosk slot and uses a kiosk interface to enter the information to be marked on the tag. The kiosk moves the cassette into a marking position, marks the tag and then outputs the cassette to the consumer. The consumer can then remove the tag from the cassette for attachment to a pet collar.

The cassettes are a consumable item that can be costly for the pet tag manufacturer/seller. One known cassette configuration is shown in FIG. 33 and includes a cassette body formed by a cassette lid 210 and a cassette base 212. A paper insert 214 is provided. The pet tag 216 seats in a recess 218 of the cassette base, and an attachment ring 220 seats in a corresponding recess 222. The paper insert 214 is placed atop the cassette base and the cassette lid 210 is pivotably connected to the base 212 by lid hinge pins 224 that engage in hinge slots 226 of the base. Windows 228, 230 in the lid and base provide machine access to both sides of the tag for marking while the tag is retained in the cassette. The cassette lid 210 may be of clear plastic to enable viewing of information printed on the top side of the paper insert 214, and the cassette base includes an additional window 232 to enable scanning of an identification bar code printed on the bottom side of the paper insert 214. When the cassette lid 10 is closed against the cassette base, retaining structure 234 at the window 228 presses against the tag 216 to help fix and stabilize the tag in the cassette. Other two-piece cassette body configurations that sandwich the pet tag are also known.

It would be desirable to provide a pet tag cassette assembly that is simpler and less expensive.

### SUMMARY

In one aspect, a single piece cassette body is provided for selective use in holding either a first tag or a second tag during engraving in an engraving machine, wherein the first tag has a first peripheral shape and the second tag has a second peripheral shape that is different than the first peripheral shape. The cassette body includes a first major side and a second major side and a periphery formed by minor edges and a tag capture space internally of the first major side, the second major side and the minor edges of the cassette body. The first major side of the cassette body includes a first tag access opening through which tag engraving can be performed, the second major side including a second tag access opening through which tag engraving can be performed. The first tag access opening is defined, at least in part, by first tag engaging structure of the first major side, the second tag access opening defined, at least in part, by second tag engaging structure of the second major side. The first tag engaging structure is shaped and positioned such that both (i) at least some portions of the first tag engaging structure will contact peripheral portions of the first tag when loaded into the tag capture space of the cassette body and (ii) at least some portions of the first tag engaging structure will contact peripheral portions of the second tag when loaded into the tag capture space of the cassette body. The second tag engaging structure is shaped and positioned such that both (i) at least some portions of the second tag engaging structure will contact peripheral portions of the first tag when loaded into the tag capture space of the cassette body and (ii) at least some portions of the second tag engaging structure will contact peripheral portions of the second tag when loaded into the tag capture space of the cassette body.

In another aspect, a method of producing pet tag cassette assemblies, involves: utilizing a supply of cassettes of a first configuration and a supply of cassettes of a second configuration; loading tags of a first peripheral configuration, located within an associated framing panel having a tag holding opening of a first configuration, into cassettes of the first configuration; loading tags of a second peripheral configuration, located within an associated framing panel having a tag holding opening of a second configuration, into cassettes of the first configuration; loading tags of a third peripheral configuration, located within an associated framing panel having a tag holding opening of a third configuration, into cassettes of the second configuration; and loading tags of a fourth peripheral configuration, located within an associated framing panel having a tag opening of a fourth configuration, into cassettes of the second configuration.

In another aspect, a tag cassette assembly is provided for use in connection with an engraving process carried out in an engraving machine. The assembly includes a single piece cassette body of plastic material, the cassette body including a first major side and a second major side and a periphery formed by minor edges; a tag secured in a capture space of the cassette body; wherein the first major side is configured to provide access to a first side of the tag to facilitate engraving and the second major side is configured to provide access to a second side of the tag to facilitate engraving; wherein the tag is held within an opening of a tag framing panel, wherein the capture space of the single piece cassette body is formed by a lateral slot along one minor edge and into which the tag framing panel slidingly engages into a final position in order to locate the tag in a set position within the capture space for engraving; wherein the tag has a thickness that is greater than the thickness of the tag framing panel.

In a further aspect, a tag cassette assembly for use in connection with an engraving process carried out in an engraving machine, the assembly comprising: a single piece cassette body of plastic material, the cassette body including a first major side and a second major side and a periphery formed by minor edges; a tag secured in a capture space of the cassette body; wherein the cassette first major side is configured to provide access to a first side of the tag to facilitate engraving and the second major side is configured to provide access to a second side of the tag to facilitate engraving.

In another aspect, a tag cassette assembly for use in connection with an engraving process carried out in an engraving machine includes a single piece cassette body of plastic material, the cassette body including a first major side and a second major side and a periphery formed by minor edges. The cassette body forms a capture space for holding a tag and a tag framing panel, wherein the capture space is formed by a lateral slot along one of the minor edges for slidingly receiving the tag and the tag framing panel. Within a periphery of the capture space, the first major side of the cassette body includes both tag engaging structure and tag framing panel engaging structure. Within the periphery of the capture space, the second major side of the cassette body includes both tag engaging structure and tag framing panel engaging structure. The tag engaging structure and tag framing panel engaging structure of the first major side does not align with the tag engaging structure and tag framing panel engaging structure of the second major side.

In a further aspect, a tag cassette assembly for use in connection with an engraving process carried out in an engraving machine includes a cassette body of plastic material, the cassette body including a first major side and a second major side and a periphery formed by minor edges. The cassette body forms a capture space for holding a tag and a tag framing panel, wherein the capture space is formed by a lateral slot along one of the minor edges for slidingly receiving the tag and the tag framing panel. Within a periphery of the capture space, the first major side of the cassette body includes both tag engaging structure and tag framing panel engaging structure. Within the periphery of the capture space, the second major side of the cassette body includes both tag engaging structure and tag framing panel engaging structure.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1-7 show one embodiment of a tag cassette assembly;

FIGS. 8-9 show another embodiment of a cassette body;

FIGS. 10-16 show another embodiment of a tag cassette assembly;

FIGS. 17-21 show another embodiment of a tag cassette assembly;

FIGS. 22-23 show another embodiment of a cassette body;

FIGS. 24-25 show another embodiment of a cassette body;

FIGS. 26-31 show another embodiment of a tag cassette assembly;

FIG. 32 shows another attachment ring recess configuration;

FIG. 33 shows a prior art cassette assembly;

FIGS. 34-40 show another embodiment of a tag cassette assembly, with FIGS. 37 and 38 being cross-sections along a plane parallel to the major sides, and with FIGS. 39 and 40 being cross-sections along a plane perpendicular to the major sides; and

FIGS. 41-42 show the cassette body of FIGS. 34-40 holding a different tag shape; and

FIGS. 43-46 show another cassette body configuration adapted for holding two different tag shapes.

### DETAILED DESCRIPTION

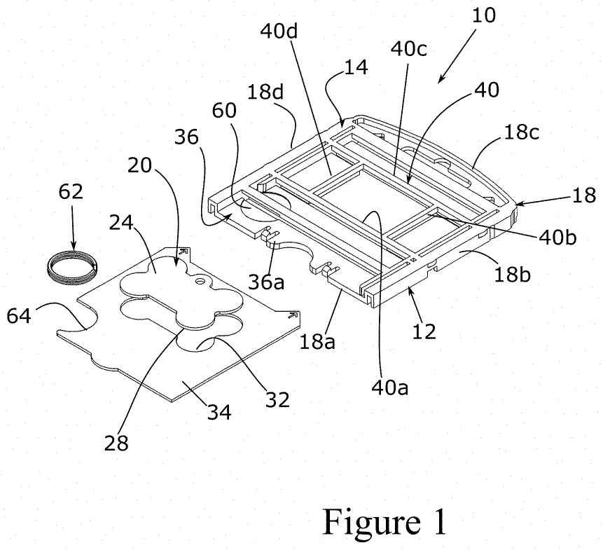

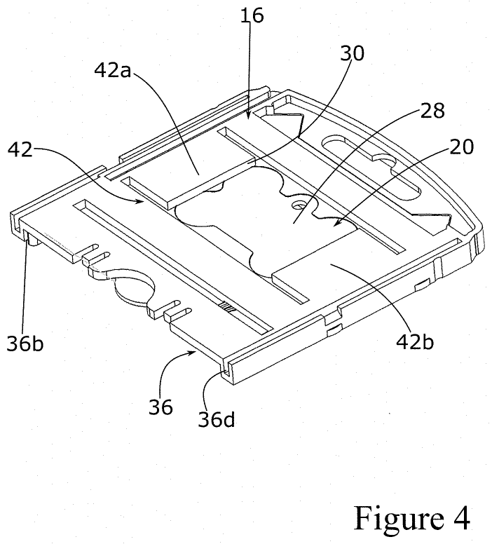

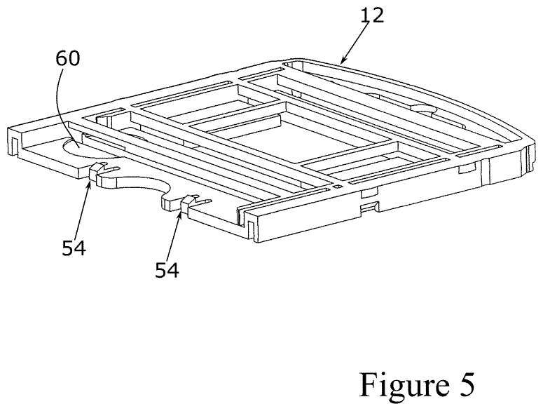

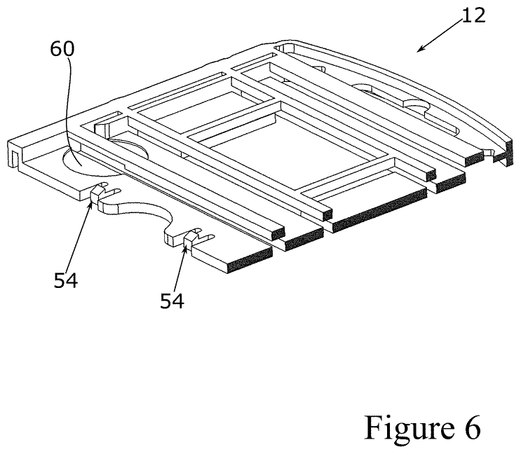

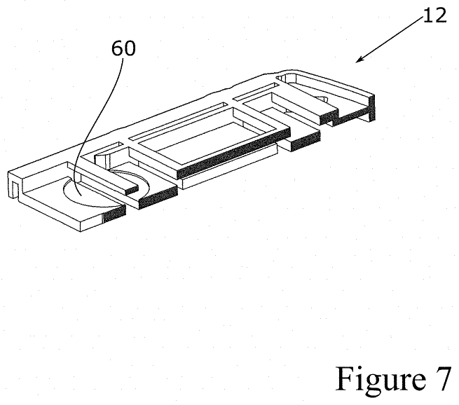

Referring to FIGS. 1-7, one embodiment of a tag cassette assembly 10 is shown and includes a single piece cassette body 12 (e.g., of a plastic material,). The cassette body includes a first major side 14 and a second major side 16 and a periphery 18 formed by minor edges 18a-18d. A tag 20 is secured in a capture space 22 of the cassette body 12. The cassette first major side 14 is configured to provide access to a first side 24 of the tag 20 (e.g. via opening 26) to facilitate engraving and the second major side 16 is configured to provide access to a second side 28 of the tag (e.g., via opening 30) to facilitate engraving.

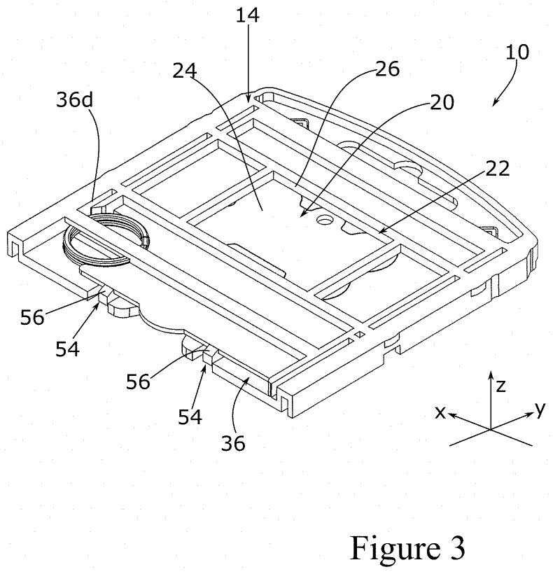

The tag 20 is held within an opening 32 of a die cut card 34 (e.g., of paper or paperboard material) or other tag framing panel. The capture space of the single piece cassette body 12 is formed by a lateral slot 36 along the minor edge 18a and into which the die cut card 34 slidingly engages (per arrows 38) into a final position (FIG. 3) in order to locate the tag in a set position within the capture space for engraving. In the set position of the tag, the opposite sides 24 and 28 of the tag align with the openings 26 and 30.

The first major side 14 of the cassette body 12 includes tag engaging structure 40 (e.g., beams 40a-40d) along at least a portion of a periphery the tag 20 when the tag is in the set position, and the second major side 16 of the cassette body 12 includes tag engaging structure 42 (e.g., walls 42a-42b) along at least a portion of the periphery of the tag when the tag is in the set position. This structure retains the tag in the z-direction for the purpose of keeping the tag stationary during engraving.

An internal end 36c of the lateral slot 36 includes a card stop edge with one or more card alignment features 44, and the die cut card includes corresponding card alignment features 46 that engage into the card alignment features 44 when the die cut card is in the final position. Here, the card alignment features 44 are female and triangular in shape with adjoining angled sides 46, 48, and the card alignment features 46 are male and triangular in shape with adjoining angled sides 50, 52 that mate by engagement with the adjoining angled sides of the card alignment features 44. An entry end 36a of the lateral slot includes at least one or more retaining tabs 54 that include tapered entry surfaces 56 to facilitate insertion of the card. The inwardly facing edges of the tabs define card edge stops. The opposed sides 36b and 36c of the lateral slot are have card edge contacting surfaces. The combination of the tabs and card stop edges of the slot holds the die cut card in place in the x and y directions, and the card 34 in turn holds the tag 20 in place in x and y directions for keeping the tag 20 stationary during engraving.

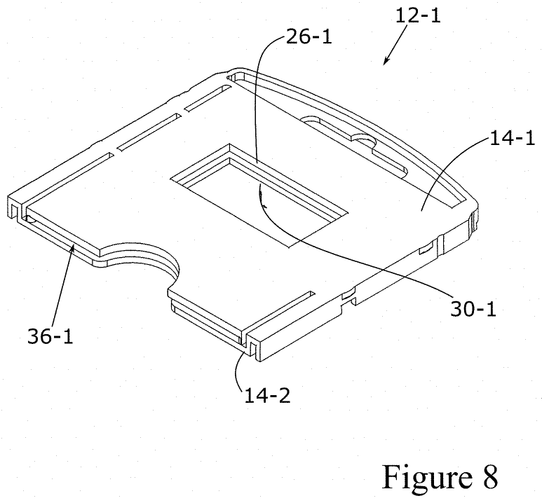

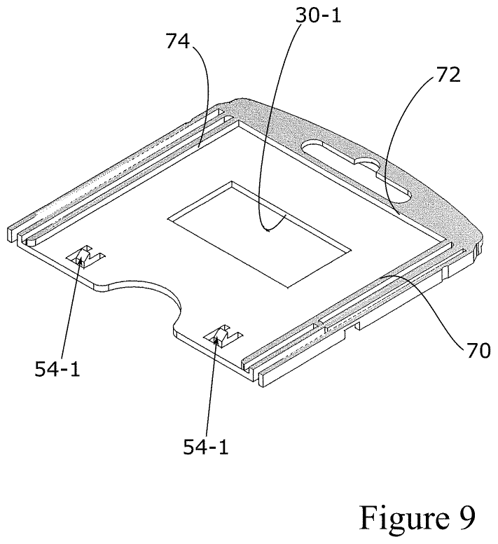

As shown, the cassette body 12 may also include a recess 60 for receiving an attachment ring 62, with the card 34 having a cutout 64 for x and y retention of the attachment ring 62. The cassette body may be of a clear plastic material through which indicia on a surface of the die cut card 34 can be viewed. Here, major side 14 of the body 12 is of a skeletal type configuration, such as may be formed by a mold with a two direction pull. However, using a more complex mold, such as a mold with a slide, both major sides can be formed with more complete continuity, as suggested by the embodiment of the cassette body 12-1 shown in FIGS. 8 and 9, where opposed major sides 14-1 and 14-2, with respective openings 26-1 and 30-1, enable capture of a die cut card and tag (not shown) within a lateral slot 36-1. Card retaining edges 70, 72, 74 and card retaining tabs 54-1 are also provided.

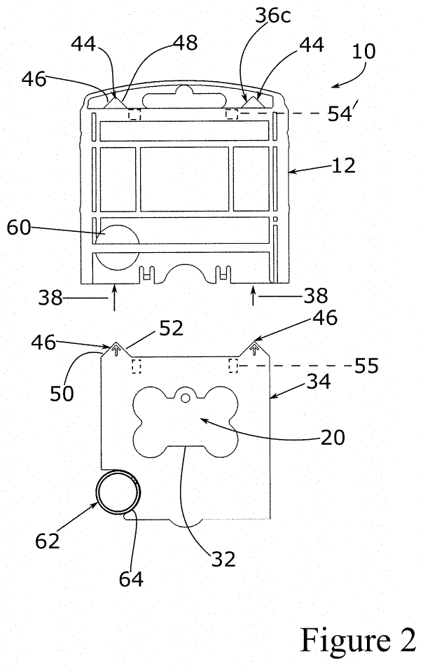

In variations of either the cassette assembly 10 or the cassette assembly 10-1, the retaining tabs 54, 54-1 could be moved away from the entry end and toward the internal end of the lateral slot (e.g., into position 54′ as seen in FIG. 2) for engagement with slots exemplary slots 55 located on the die cut card. Such an arrangement would place the capturing/retaining feature near the leading edge of the card, so there is no resistance to card insertion in the lateral slot until the card is almost fully seated. In such cases, removal of the card could possibly involve tearing the card at the slots 55.

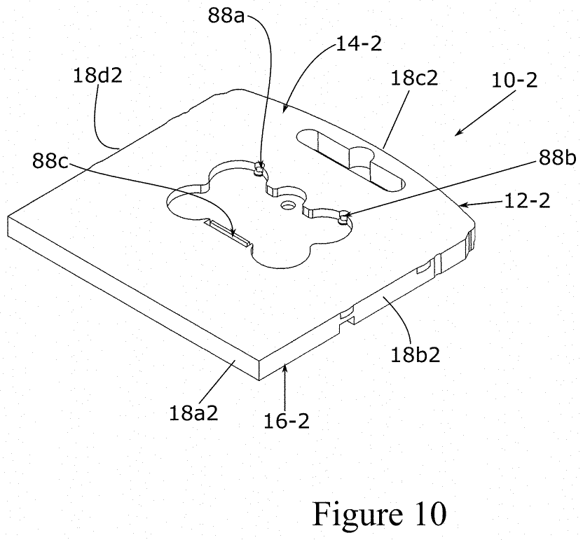

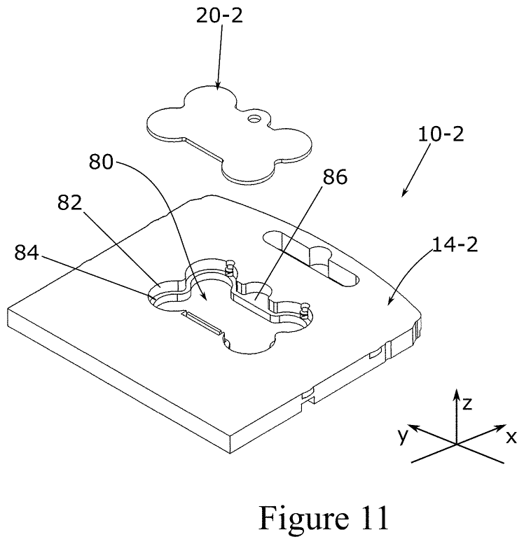

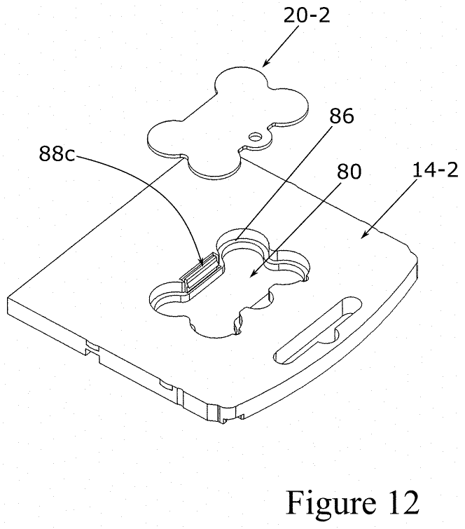

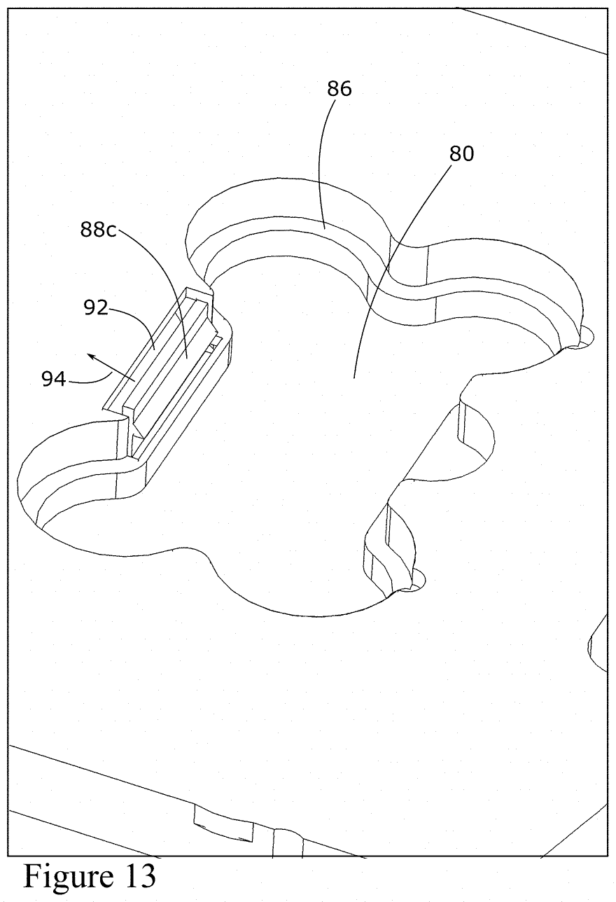

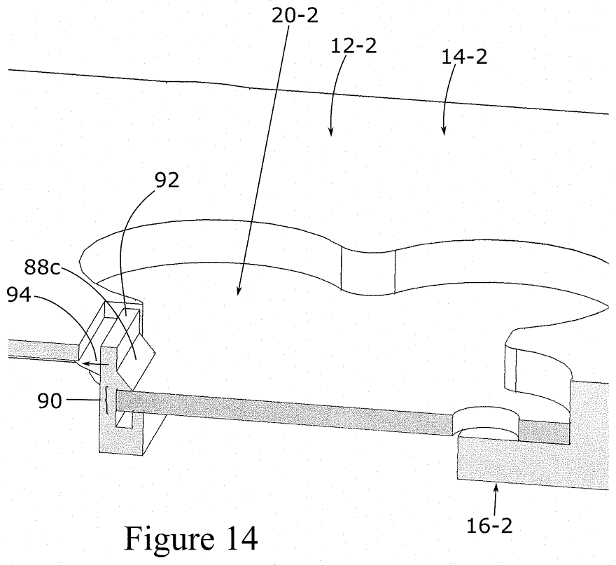

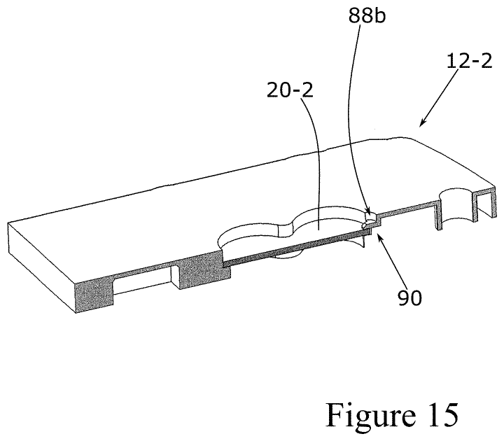

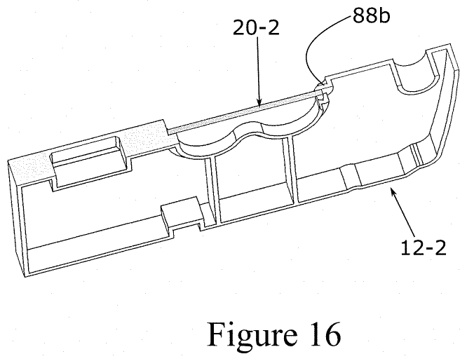

Another embodiment of a tag cassette assembly 10-2 is shown in FIGS. 10-16 and includes a cassette body 12-2 with opposed major sides 14-2 and 16-2 and minor edges 18a2-18d2. The cassette body 12-2 includes a through opening 80 comprised by a recess 82 into the major side 14-2, with a bottom 84 of the recess defined by an inwardly extending rim 86 of the major side 16-2, where the inwardly extending rim 86 defines a periphery of the through opening 80 at the major side 16-2. The recess 82 includes a plurality of retention tabs 88a, 88b, 88c positioned relative to the inwardly extending rim 86 so as to form a retention gap 90 therebetween that at least in part defines the capture space for the tag 20-2. Peripheral portions of one side 26-2 of the tag seat against the inwardly extending rim 86 and peripheral portions of the other side 24-2 of the tag are engaged by the plurality of tabs. At least one of the tabs 88c is configured to be able to flex outwardly (e.g. wall 92 can flex outward per arrow 94) for insertion of the tag into the recess.

In the tag cassette assembly 10-2, retention of the tag 20-2 in the z-direction is provided by the rim 86 and tabs 88a-88c, and retention of tag 20-2 in the x and y directions is provided by the periphery of the recess 82.

The cassette body 12-2 may be of a clear plastic material with an adhesive decal applied to the major side 14-2. Alternatively, the cassette body may be of a plastic (e.g., PET) that is direct surface printed on the major side 14-2 and/or the major side 16-2.

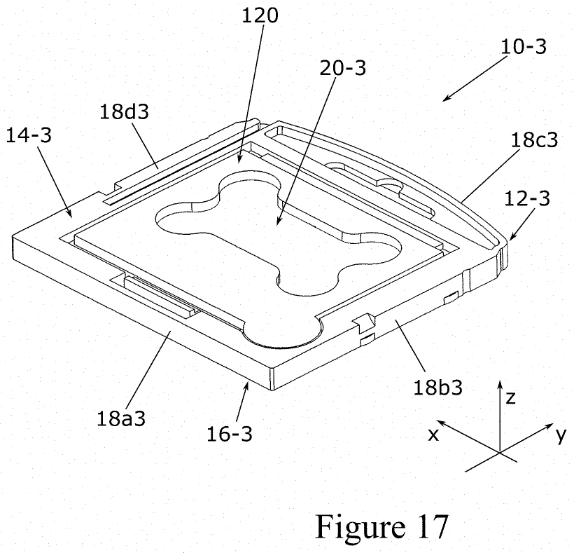

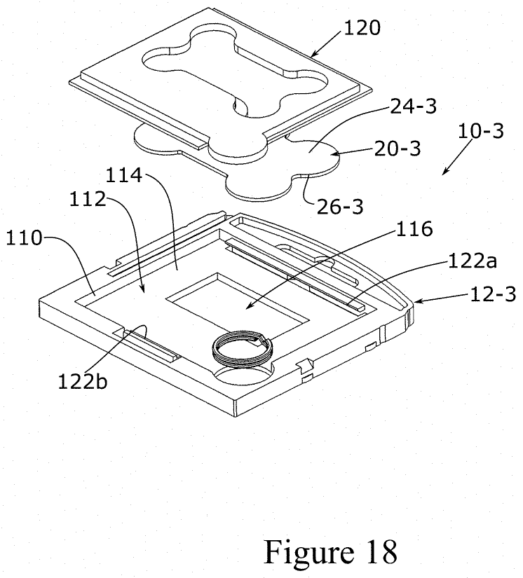

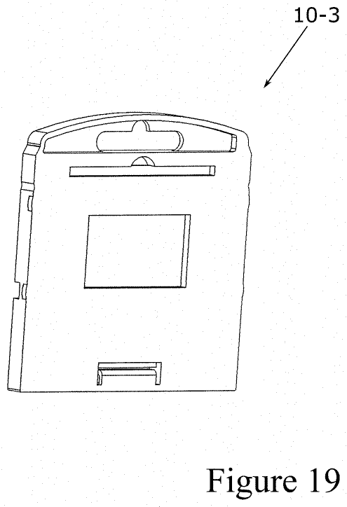

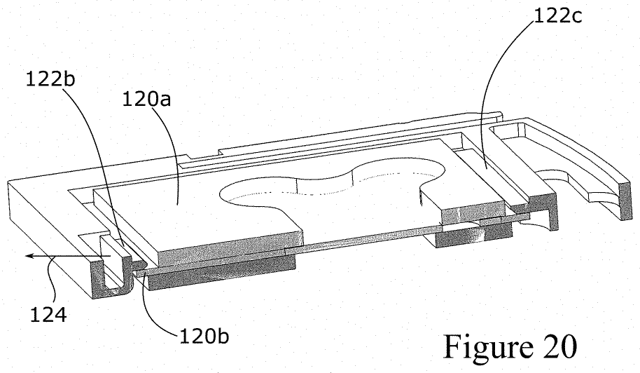

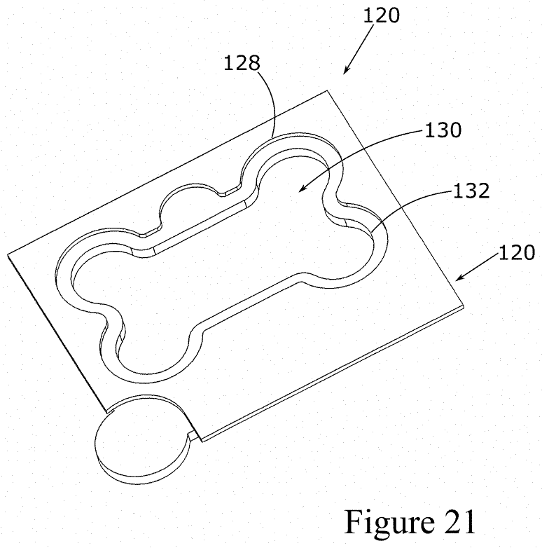

Another embodiment of a tag cassette assembly 10-3 is shown in FIGS. 17-20 and includes a cassette body 12-3 with opposed major sides 14-3 and 16-3 and minor edges 18a3-18d3. The cassette body includes a recess 110 into the major side 14-3, where a bottom 112 of the recess is defined by a wall 114 of the major side 16-3. The wall 114 includes a through opening 116, and the tag 20-3 is positioned in the recess 110 with one side 26-3 at least partially aligned with the through opening 116. A laminated die cut card 120 is also seated in the recess 110, over the tag 20-3 to retain the tag in the recess. The recess 110 includes peripheral retention tabs 122a, 122b and edge portions of the laminated die cut card 120 are positioned beneath the retention tabs 122a, 122b to hold the laminated die cut card 120, and thus the tag 20-3, within the recess. At least one of the retention tabs 122b is configured to be able to flex outwardly (per arrow 124) for insertion of the laminated die cut card 120 into the recess. The laminated die cut card 120 includes a seating recess 128 for the tag 20-3, and a through opening 130 defined by a seating rim 132 of the recess 128. The seating recess 128 is formed by the relative shape and size of the openings in the laminated card sheet parts 120a and 120b. The car sheet parts 120a may be held to each other by adhesive, stitching or material weld. Card sheet part 120a may be of clear plastic.

In the tag cassette assembly 10-3, retention of the tag 20-3 in the z-direction is provided by the wall 114 and the seating rim 132 of the card 120, and retention of tag 20-3 in the x and y directions is provided by the periphery of the recess 128.

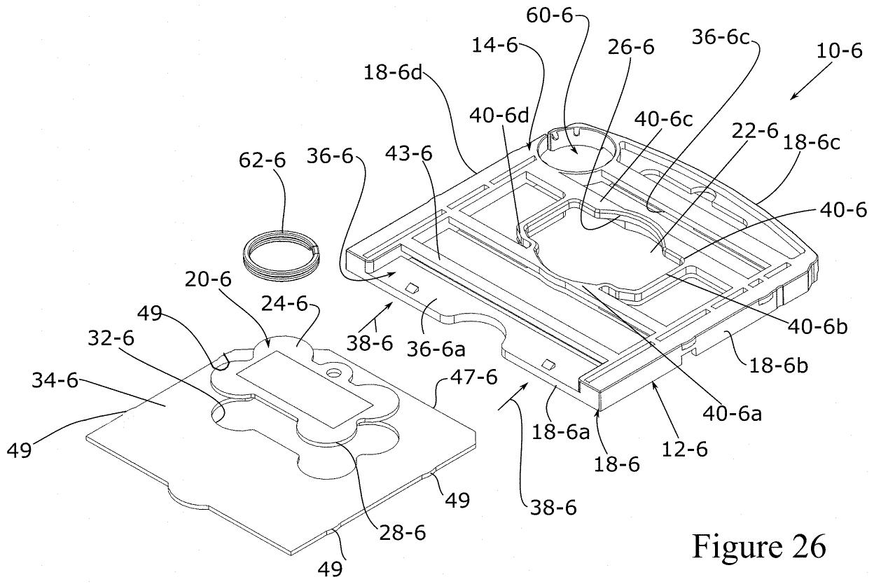

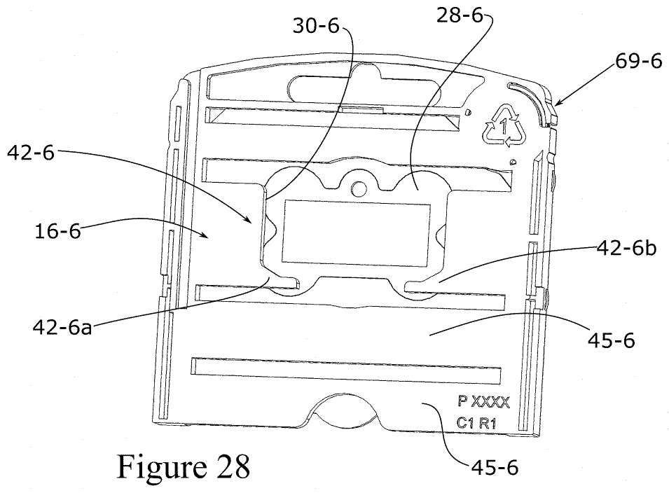

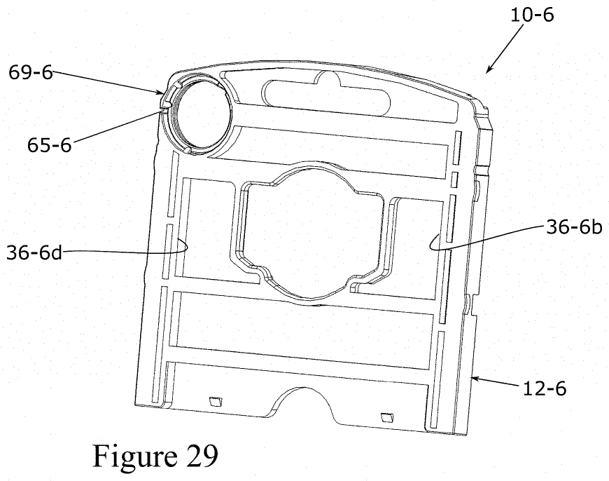

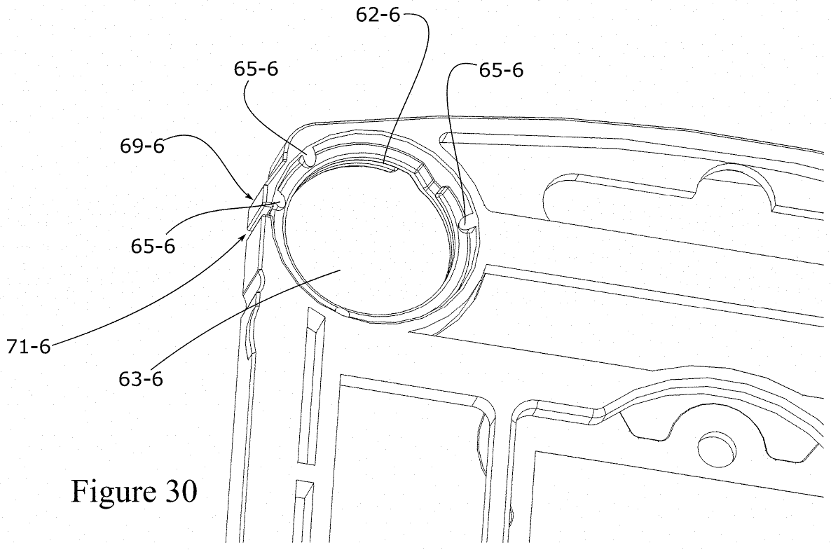

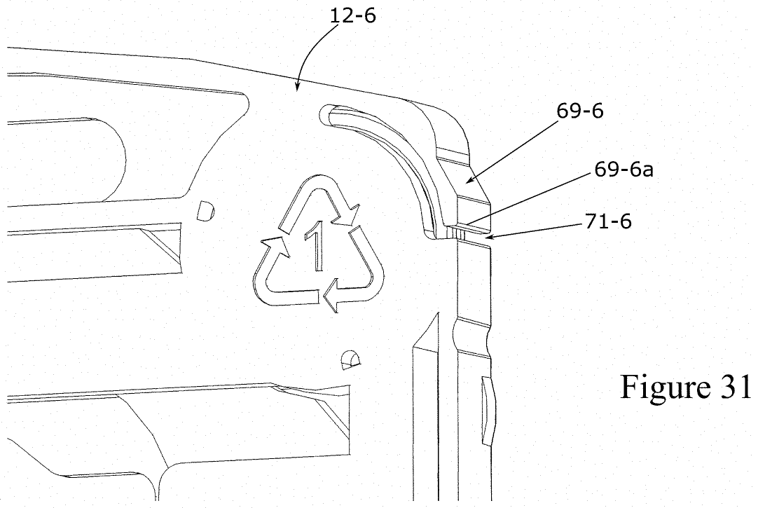

Referring to FIGS. 26-31, another embodiment of a tag cassette assembly 10-6 is shown and includes a single piece cassette body 12-6 (e.g., of a plastic material,). The cassette body includes a first major side 14-6 and a second major side 16-6 and a periphery 18-6 formed by minor edges 18-6a through 18-6d. A tag 20-6 is secured in a capture space 22-6 of the cassette body 12-6. The cassette first major side 14-6 is configured to provide access to a first side face 24-6 of the tag 20-6 (e.g. via opening 26-6) to facilitate engraving and the second major side 16-6 is configured to provide access to a second side face 28-6 of the tag (e.g., via opening 30-6) to facilitate engraving.

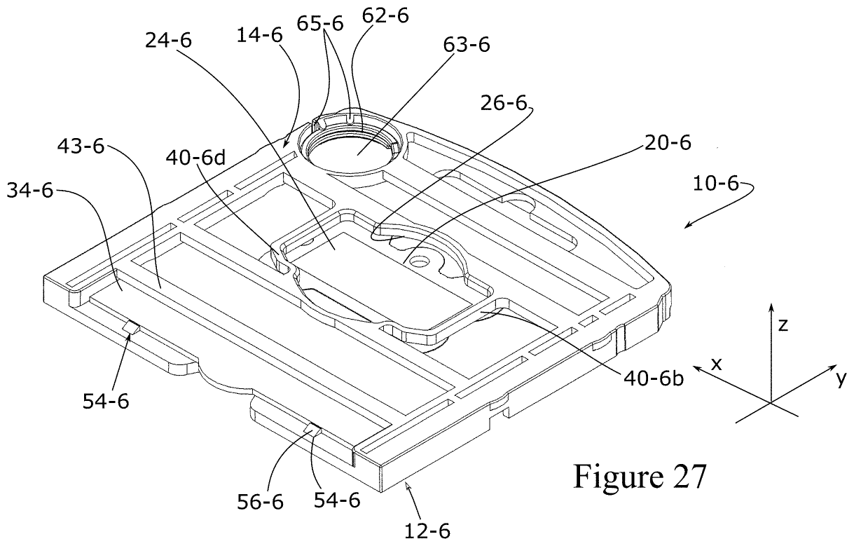

The tag 20-6 is held within an opening 32-6 of a die cut card 34-6 (e.g., of paper or paperboard material) or other tag framing panel. The capture space of the single piece cassette body 12-6 is formed by a lateral slot 36-6 along the minor edge 18-6a and into which the die cut card 34-6 slidingly engages (per arrows 38-6) into a final position (FIG. 27) in order to locate the tag in a set position within the capture space for engraving. In the set position of the tag, the opposite side faces 24-6 and 28-6 of the tag align with the openings 26-6 and 30-6.

The first major side 14-6 of the cassette body 12-6 includes tag engaging structure 40-6 (e.g., beams 40-6a through 40-6d) along at least a portion of a periphery the tag 20-6 when the tag is in the set position, and the second major side 16-6 of the cassette body 12-6 includes tag engaging structure 42-6 (e.g., wall portions 42-6a through 42-6b) along at least a portion of the periphery of the tag when the tag is in the set position. This structure retains the tag in the z-direction for the purpose of keeping the tag stationary during engraving. Each of the first major side 14-6 and the second major side 16-6 also includes respective tag framing panel engaging structure 43-6 or 45-6. Notably, in the illustrated embodiment, the tag engaging structure and tag framing panel engaging structure of the first major side does not align (in plan view perpendicular to the plane of either of the major sides) with the tag engaging structure and tag framing panel engaging structure of the second major side. The configuration of the tag engaging structure can vary depending upon the shape and size of the tag to be held by the cassette body.

An internal end 36-6c of the lateral slot 36-6 includes a card stop edge for engaging with a leading side edge 47-6 of the tag framing panel, when the tag framing panel is in the final position. An entry end 36-6a of the lateral slot includes one or more retaining tabs 54-6 that include tapered entry surfaces 56-6 to facilitate insertion of the card. The inwardly facing edges of the tabs define card edge stops. Here, the tabs 54-6 are in fixed, non-moving positions on part of the tag framing panel engaging structure of the second major side 16-6.

The opposed sides 36-6b and 36-6d of the lateral slot have panel edge contacting surfaces. The combination of the tabs and panel stop edges of the slot holds the panel in place in the x and y directions, and the panel 34-6 in turn holds the tag 20-6 in place in x and y directions for keeping the tag 20-6 stationary during engraving. Here, the panel 34-6 includes opposed side edges each having one or more projecting edge features 49 (here curved bump-outs) for positively engaging with panel edge contacting surfaces of the lateral slot.

As shown, the cassette body 12-6 also include a recess 60-6 for receiving an attachment ring 62-6. Here, the recess 60-6 in which the attachment ring is held is offset from the capture space 22-6. The recess 60-6 includes a bottom portion 63-6 defined by the second major side, and multiple ring retaining tabs 65-6 at the first major side for securing the attachment ring within the recess and against the bottom 63-6. A periphery of the recess 60-6 is defined at least in part by a removable finger 69-6 that is configured to be manually broken away from the cassette body. Here, a slot 71-6 is provided to define a free end 69-6a of the finger that is graspable by a user. The finger includes runs along a slot that helps define the finger the slot includes a slot end, at which point the finger typically breaks away from the cassette body when pulled by a user. Here, one or more of the ring retaining tabs 65-6 are located on the removable finger, so that once the finger is broken away, the attachment ring 62-6 can be manually pulled from the recess 60-6. In an alternative embodiment, per FIG. 32, some or all of the finger may be eliminated along the ring recess 60-7. In such case, one side of the recess at the periphery of the cassette body may be open, such that the attachment ring recess includes an unbounded side portion along a portion of a peripheral edge of the cassette body. The inserted attachment-ring 62-7 then includes a peripheral portion 61 that is exposed for enabling a person to grasp and remove the ring 62-7, in some cases without requiring breaking away of any finger or, here small finger part 69-7.

The cassette body may be of a clear plastic material through which indicia (e.g., graphics and/or bar code) on a surface of the tag framing panel 34-6 can be viewed. A bar code printed on the framing panel may also be aligned with one of the open, uncovered spaces at the major side 14-6, so as to be readily scannable by a scanner in an engraving machine and/or other point-of-sale. Here, major side 14-6a of the body 12-6 is of a skeletal type configuration, such as may be formed by a mold with a two direction pull. However, using a more complex mold, such as a mold with a slide, both major sides can be formed with more complete continuity.

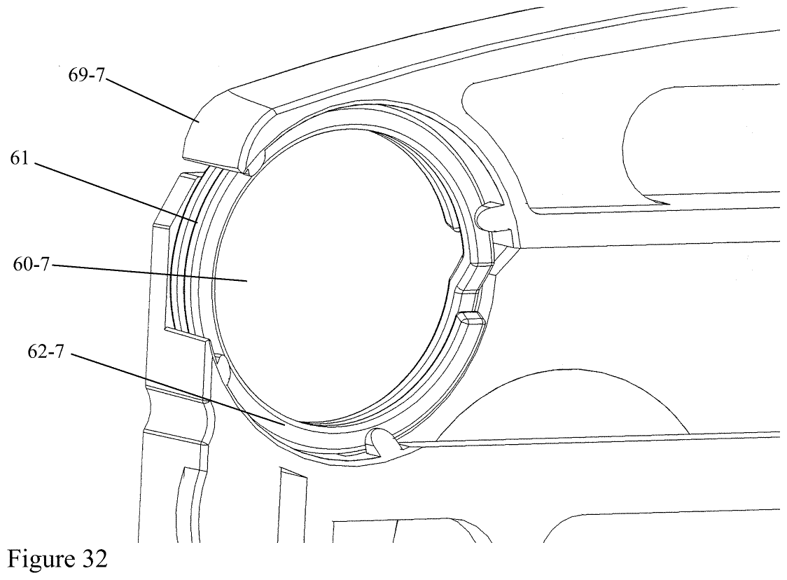

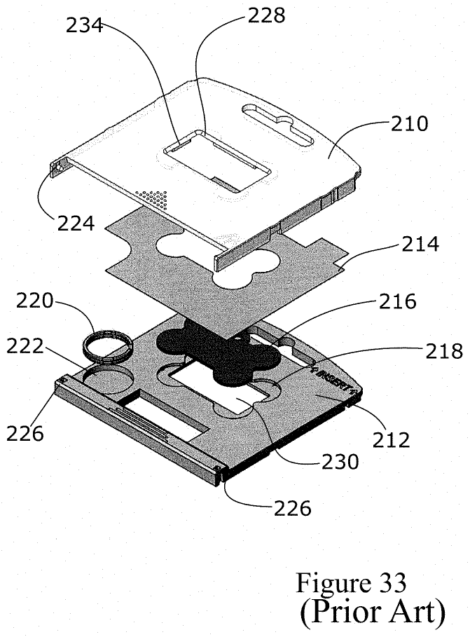

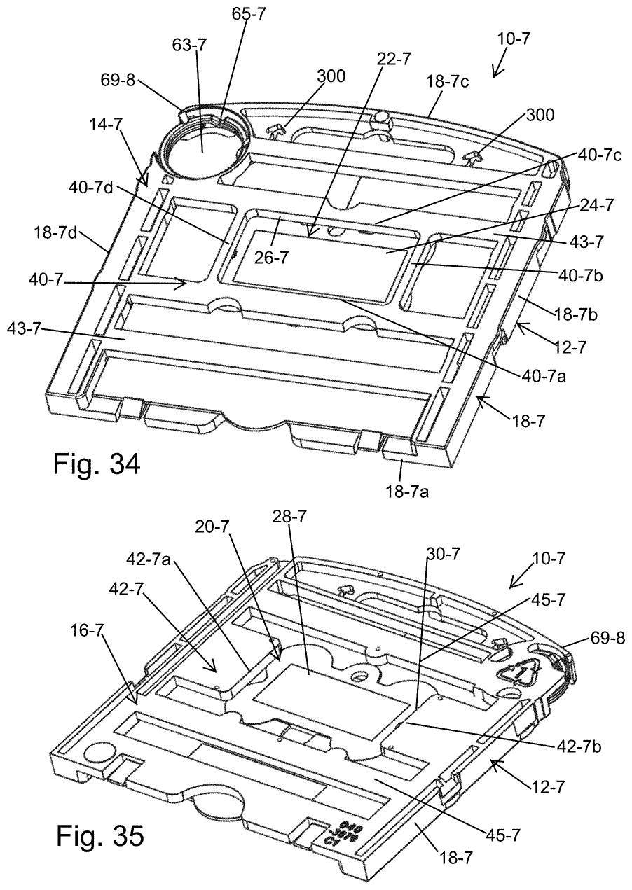

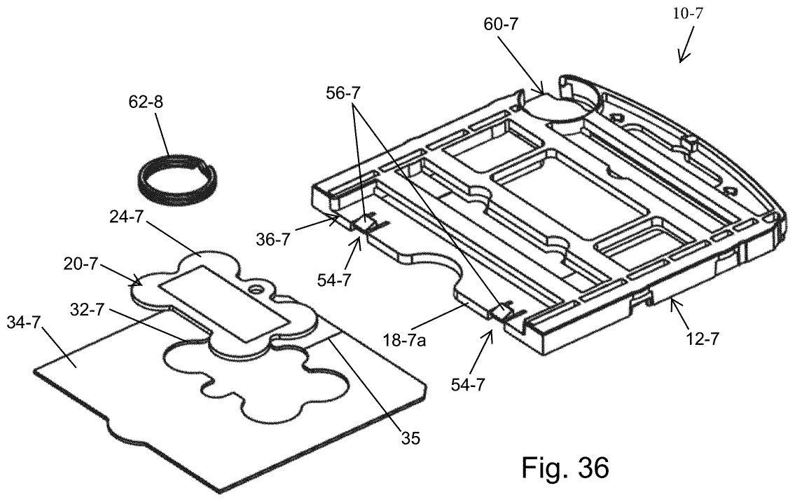

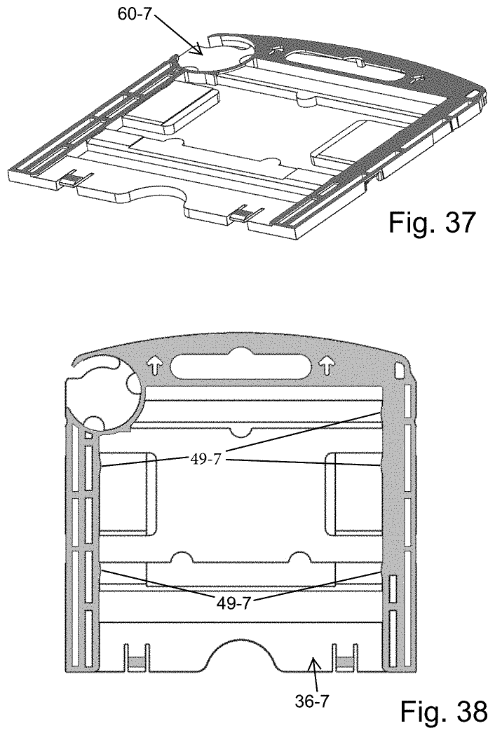

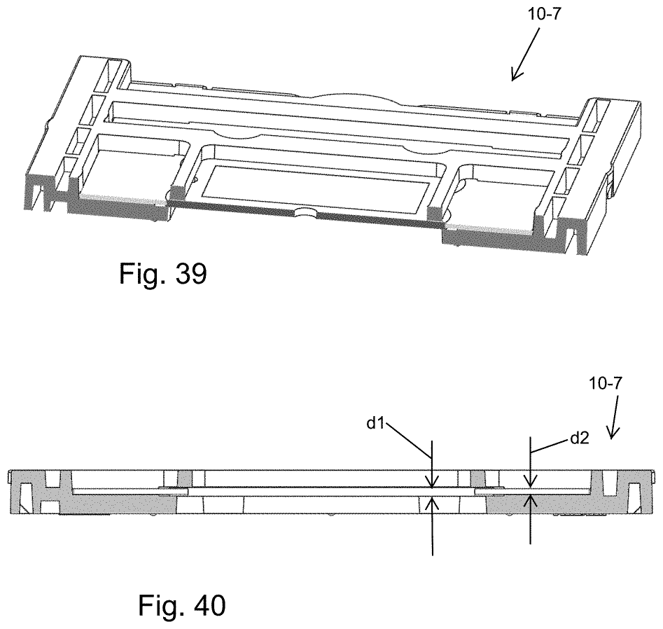

Referring to FIGS. 34-40, another embodiment of a tag cassette assembly 10-7 is shown and includes a single piece cassette body 12-7 (e.g., of a plastic material,). The cassette body includes a first major side 14-7 and a second major side 16-7 and a periphery 18-7 formed by minor edges 18-7a through 18-7d. A tag 20-7 is secured in a capture space 22-7 of the cassette body 12-7. The cassette first major side 14-7 is configured to provide access to a first side face 24-7 of the tag 20-7 (e.g. via opening 26-7) to facilitate engraving and the second major side 16-7 is configured to provide access to a second side face 28-7 of the tag (e.g., via opening 30-7) to facilitate engraving.

The tag 20-7 is held within an opening 32-7 of a die cut card 34-7 (e.g., of paper or paperboard material) or other tag framing panel. The capture space of the single piece cassette body 12-7 is formed by a lateral slot 36-7 along the minor edge 18-7a and into which the die cut card 34-7 slidingly engages into a final position (FIG. 34) in order to locate the tag in a set position within the capture space for engraving. In the set position of the tag, the opposite side faces 24-7 and 28-7 of the tag align with the openings 26-7 and 30-7.

The first major side 14-7 of the cassette body 12-7 includes tag engaging structure 40-7 (e.g., beams or beam portions 40-7a through 40-7d) along at least a portion of a periphery the tag 20-7 when the tag is in the set position, and the second major side 16-7 of the cassette body 12-7 includes tag engaging structure 42-7 (e.g., wall portions 42-7a through 42-7b) along at least a portion of the periphery of the tag when the tag is in the set position. This structure retains the tag in the z-direction for the purpose of keeping the tag stationary during engraving. Each of the first major side 14-6 and the second major side 16-6 also includes respective tag framing panel engaging structure 43-7 or 45-7. Notably, in the illustrated embodiment, the tag engaging structure and tag framing panel engaging structure of the first major side does not align (in plan view perpendicular to the plane of either of the major sides) with the tag engaging structure and tag framing panel engaging structure of the second major side. The configuration of the tag engaging structure can vary depending upon the shape and size of the tag to be held by the cassette body.

Here, the tag 20-7 has a thickness that is greater than the thickness of the tag framing panel. Accordingly, the internally facing surfaces of the tag engaging structure are spaced apart by a distance d1 that is slightly greater than the distance d2 between the internally facing surfaces of the tag framing panel engaging structure. This configuration permits the use of a thinner, less expensive tag framing panel, while at the same time keeping both the tag framing panel and the tag centered in the z direction. Where the tag framing panel is of a slightly compressible material, such as paperboard, the tag panel engaging structure will slightly compress or crush the paperboard, providing increased holding strength on the tag framing panel.

An entry end 36-7a of the lateral slot includes one or more retaining tabs 54-7 that include tapered entry surfaces 56-7 to facilitate insertion of the card. The inwardly facing edges of the tabs define card edge stops. Here, the tabs 54-7 are positioned at the free end of flex arms that permit some movement or flex of the tabs. The opposed sides of the lateral slot have panel edge contacting surfaces. The combination of the tabs and panel stop edges of the slot holds the panel in place in the x and y directions, and the panel 34-7 in turn holds the tag 20-7 in place in x and y directions for keeping the tag 20-6 stationary during engraving. Here, the panel 34-7 includes opposed side edges that are linear, and the panel edge contacting surfaces of the include projecting features 49-7 (here curved bump-outs) for positively engaging with panel edges to tightly hold the tag framing panel and to account for possible tolerance issues.

As shown, the cassette body 12-7 also include a recess 60-7 for receiving an attachment ring 62-8. Here, the recess 60-7 in which the attachment ring is held is offset from the capture space 22-7. The recess 60-7 includes a bottom portion 63-7 defined by the second major side, and multiple ring retaining tabs 65-7 at the first major side for securing the attachment ring within the recess and against the bottom 63-7. A periphery of the recess 60-7 is defined at least in part by a finger 69-8 that, in some cases, may be configured to be manually broken away from the cassette body. Here, one side of the recess at the periphery of the cassette body is open, such that the attachment ring recess includes an unbounded side portion along a portion of a peripheral edge of the cassette body. The inserted attachment-ring 62-8 includes a peripheral portion that is exposed for enabling a person to grasp and remove the ring 62-8, in some cases without requiring breaking away of any finger.

The cassette body may be of a clear plastic material through which indicia (e.g., graphics and/or bar code) on a surface of the tag framing panel can be viewed. A bar code printed on the framing panel may also be aligned with one of the open, uncovered spaces at the major side, so as to be readily scannable by a scanner in an engraving machine and/or other point-of-sale.

Notably, the cassette body 12-7 includes molded in directional arrows 300 that are formed as through openings so as to be visible from both major sides of the cassette body. The directional arrows are provided to communicate to the consumer the direction in which the cassette should be inserted into an engraving machine for the purpose of tag engraving.

The above-described configuration of the cassette body 12-7 and card/tag framing panel 34-7 also provides a spring-loaded card feature in that the card includes a slit 35 that extends from the opening 32-7 to the peripheral edge of the card. This allows the opening 32-7 to expand slightly when a tag is inserted into the opening, due to interference between the outer periphery of the tag and the inward facing periphery of the opening 32-7. The natural tendency of the card material is to return to a position in which the two edges along the side of the slit 35 abut each other, providing a spring-like grip or holding feature of the tag by the card. In addition, when the card is inserted into the cassette, the interaction of the card side edges and the projecting features 49-7 of the cassette further urges the two sides of the slit 35 toward each other, further squeezing the tag for secure holding.

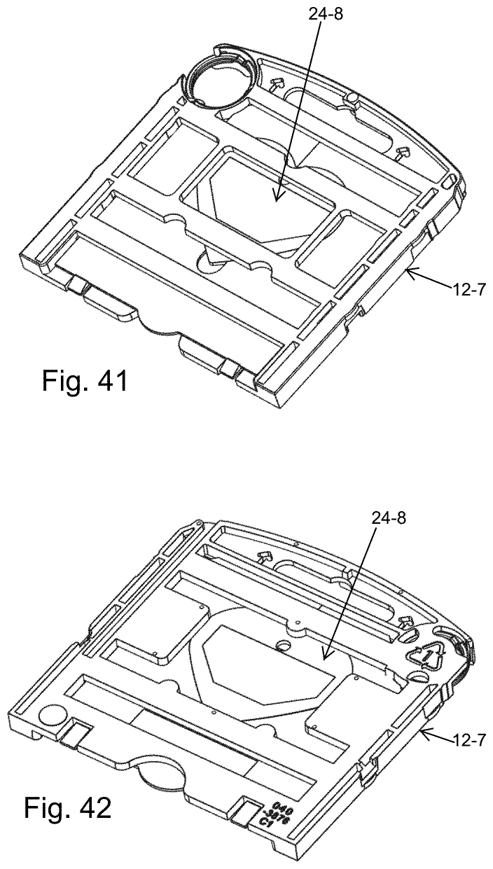

Notably, by properly positioning the tag engaging structure of the cassette body 12-7, the cassette body can be used to hold tags of varying shapes. For example, as seen in FIGS. 34-36, the cassette body 12-7 holds a large bone shaped tag, while in FIGS. 41-42, the same cassette body 12-7 is shown holding a tag framing panel with a heart-shaped tag 24-8. This feature reduces the tooling sets required to provide cassette bodies for a number of different tag shapes (i.e., a one-to-one correspondence is not required). This feature is achieved by assuring that: the tag engaging structure of the first major side is shaped and positioned both (i) for contacting peripheral portions of the first tag (e.g., large bone shape) when loaded into the tag capture space of the cassette body and (ii) for contacting peripheral portions of the second tag (e.g., heart shape) when loaded into the tag capture space of the cassette body, and the tag engaging structure of the second major side is shaped and positioned both (i) for contacting peripheral portions of the first tag when loaded into the tag capture space of the cassette body and (ii) for contacting peripheral portions of the second tag when loaded into the tag capture space of the cassette body. In some embodiments, the same cassette body may be configured to hold more than two different tag shapes.

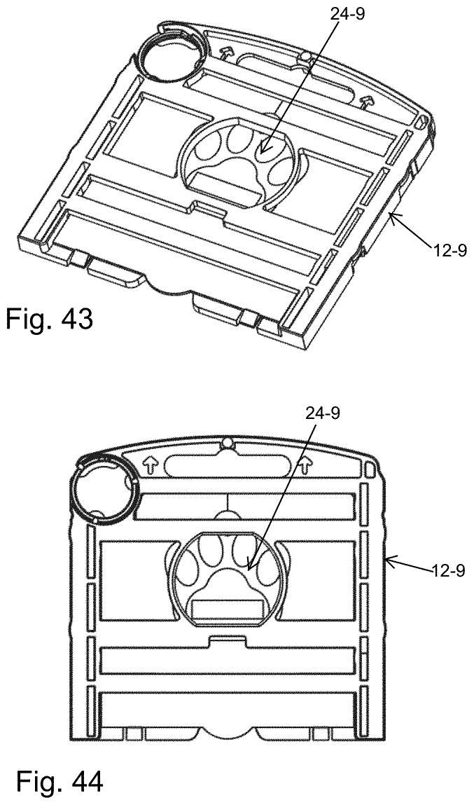

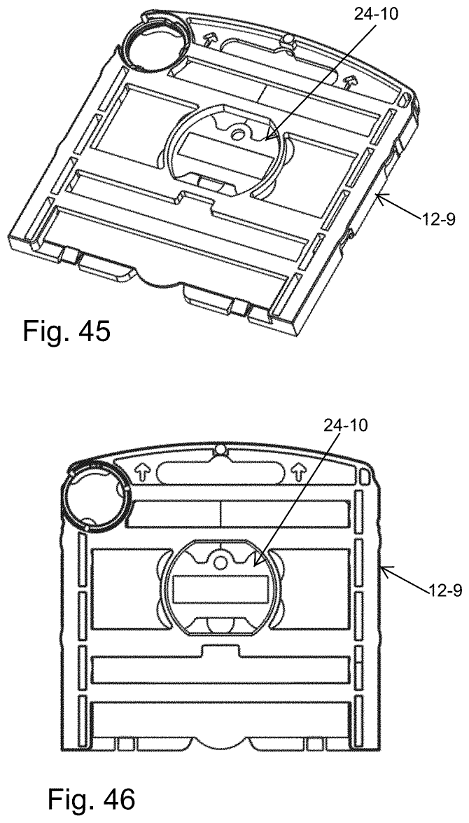

In another example, referring to FIGS. 43-46, another cassette body 12-9 is shown and includes tag engaging structure shaped and positioned so as to be suitable for holding either a paw shaped tag 24-9 or a small bone shaped tag 24-10.

This multiple tag per cassette feature of provides a system in which only a limited number of cassette configurations is required for a larger number of tag configurations, which materially reduces manufacturing costs by reducing the number of cassette molding tools/dies required. Thus, a method of production can be implemented in which, for example, a supply of cassettes of a first configuration and a supply of cassettes of a second configuration are both provided. Tags of a first configuration (within an associated framing panel having a tag holding opening of the first configuration) are loaded into cassettes of the first configuration and tags of a second configuration (with an associated framing panel having a tag holding opening of the second configuration) are also loaded into cassettes of the first configuration. Similarly, tags of a third configuration (within an associated framing panel having a tag holding opening of the third configuration) are loaded into cassettes of the second configuration and tags of a fourth configuration (with an associated framing panel having a tag opening of the fourth configuration) are also loaded into cassettes of the second configuration. The fully loaded cassettes (of both the first configuration and second configuration) can then be shipped to retailers for selection and use by consumers for personalized engraving of four differently shaped tags. As previously noted, the cassettes of the first configuration and/or the cassettes of the second configuration can, in some cases, also be capable of holding additional tag configurations (more than two different tag configurations).

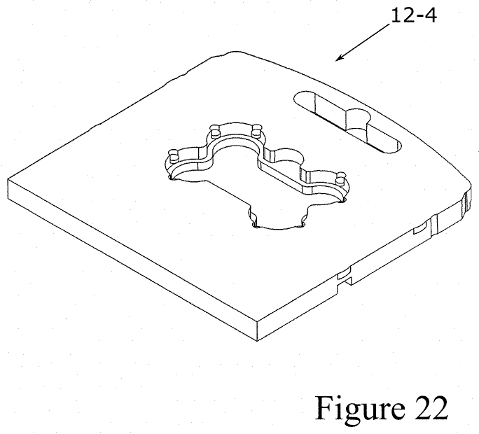

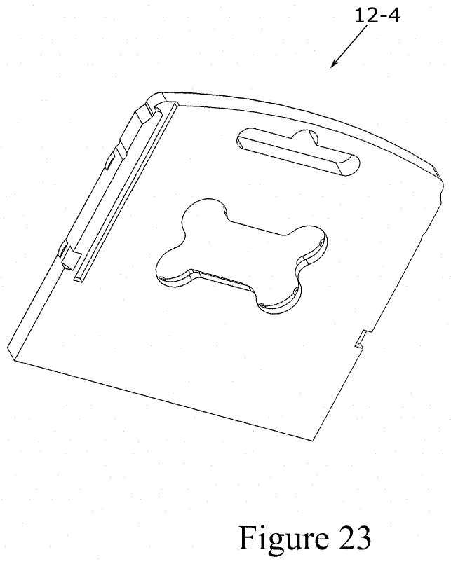

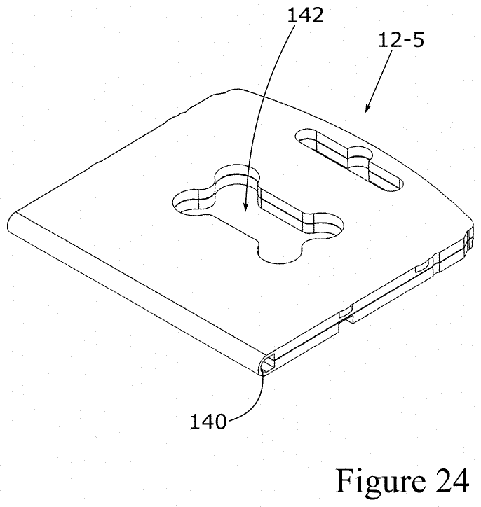

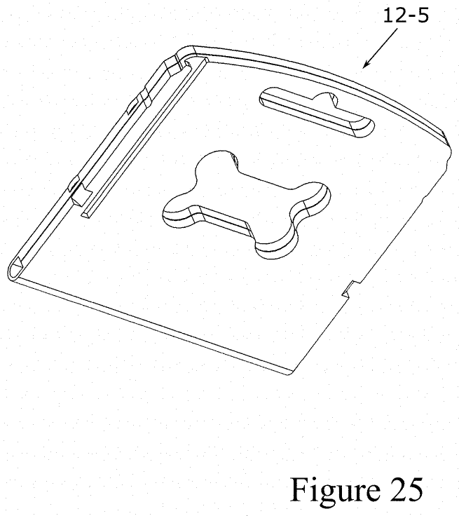

It is to be clearly understood that the above description is intended by way of illustration and example only, is not intended to be taken by way of limitation, and that other changes and modifications are possible. For example, FIGS. 22 and 23 show another embodiment of a cassette body 12-4, which is similar to cassette body 12-2 in terms of providing a tag seating recess with retention tabs, but where the cassette body 12-4 is formed of a one piece embossed/staked paperboard or a molded or die cut card that is embossed/staked. FIGS. 24 and 25 show another embodiment of a cassette body 12-5 that is formed by a folded paperboard material having a living hinge 140, where the tag would be captured between the folds in the vicinity of the opening 142. Still other variations and additional features are possible.

For example, in some embodiments, in order to better secure the tag to the tag framing panel, one or more adhesive tape segments could be provided along one or more edge portions of the tag (e.g., with part of the tape segment adhered to the tag and part of the tape segment adhered to the tag framing panel).

1. A single piece cassette body for selective use in holding either a first tag or a second tag during engraving in an engraving machine, wherein the first tag has a first peripheral shape and the second tag has a second peripheral shape that is different than the first peripheral shape, the cassette body comprising:
a first major side and a second major side and a periphery formed by minor edges;
a tag capture space internally of the first major side, the second major side and the minor edges of the cassette body;
the first major side of the cassette body including a first tag access opening through which tag engraving can be performed, the second major side including a second tag access opening through which tag engraving can be performed;
the first tag access opening defined, at least in part, by first tag engaging structure of the first major side, the second tag access opening defined, at least in part, by second tag engaging structure of the second major side;
the first tag engaging structure shaped and positioned such that both (i) at least some portions of the first tag engaging structure will contact peripheral portions of the first tag when loaded into the tag capture space of the cassette body and (ii) at least some portions of the first tag engaging structure will contact peripheral portions of the second tag when loaded into the tag capture space of the cassette body;
the second tag engaging structure shaped and positioned such that both (i) at least some portions of the second tag engaging structure will contact peripheral portions of the first tag when loaded into the tag capture space of the cassette body and (ii) at least some portions of the second tag engaging structure will contact peripheral portions of the second tag when loaded into the tag capture space of the cassette body.

2. The single piece cassette body of claim 1, for selective use in holding either the first tag or the second tag or a third tag during engraving, wherein the third tag has a third peripheral shape that is different than both the first peripheral shape and the second peripheral shape, the cassette body comprising:
the first tag engaging structure also shaped and positioned such that at least some portions of the first tag engaging structure will contact peripheral portions of the third tag when loaded into the tag capture space of the cassette body; and
the second tag engaging structure also shaped and positioned such that at least some portions of the second tag engaging structure will contact peripheral portions of the third tag when loaded into the tag capture space of the cassette body.

3. A method of producing pet tag cassette assemblies, comprising:
utilizing a supply of cassettes of a first configuration and a supply of cassettes of a second configuration;
loading tags of a first peripheral configuration, located within an associated framing panel having a tag holding opening of a first configuration, into cassettes of the first configuration;
loading tags of a second peripheral configuration, located within an associated framing panel having a tag holding opening of a second configuration, into cassettes of the first configuration;
loading tags of a third peripheral configuration, located within an associated framing panel having a tag holding opening of a third configuration, into cassettes of the second configuration; and
loading tags of a fourth peripheral configuration, located within an associated framing panel having a tag opening of a fourth configuration, into cassettes of the second configuration.

4. A tag cassette assembly for use in connection with an engraving process carried out in an engraving machine, the assembly comprising:
a single piece cassette body of plastic material, the cassette body including a first major side and a second major side and a periphery formed by minor edges;
a tag secured in a capture space of the cassette body;
wherein the first major side is configured to provide access to a first side of the tag to facilitate engraving and the second major side is configured to provide access to a second side of the tag to facilitate engraving;
wherein the tag is held within an opening of a tag framing panel, wherein the capture space of the single piece cassette body is formed by a lateral slot along one minor edge and into which the tag framing panel slidingly engages into a final position in order to locate the tag in a set position within the capture space for engraving;
wherein the tag has a thickness that is greater than the thickness of the tag framing panel.

5. The tag cassette assembly of claim 4, wherein
the first major side of the cassette body includes tag engaging structure at least along a portion of a periphery the tag when the tag is in the set position, and the second major side of the cassette body includes tag engaging structure at least along a portion of the periphery of the tag when the tag is in the set position, wherein the tag engaging structure of the first major side and the tag engaging structure of the second major side is spaced apart in a direction of the thickness of the tag by a first distance,
the first major side of the cassette body includes tag framing panel engaging structure and the second major side of the cassette body includes tag framing panel engaging structure, wherein the tag framing panel engaging structure of the first major side and the tag framing panel engaging structure of the second major side is spaced apart in a direction of the thickness of the tag framing panel by a second distance that is smaller than the first distance.

6. A tag assembly for use in connection with an engraving process carried out in an engraving machine, the assembly comprising:
a tag having a peripheral shape;
a tag framing panel having an opening corresponding to the peripheral shape, and a slit extending from the opening to an exterior edge of the tag framing panel;
wherein the tag is positioned within the opening such that the peripheral shape of the tag is in interference with inner edge portions of the opening;
wherein the tag framing panel, by operation of the slit and characteristics of the tag framing panel, provides a spring-like capture of the tag within the opening.
